(19) United States
(12) Patent Application Publication
(10) Pub. No.: US 2026/0018039 A1
(43) Pub. Date: Jan. 15, 2026

(54) A method for determining a label of a fall event

(71) Applicant: SIGNIFY HOLDING B.V., EINDHOVEN (NL)

(72) Inventors: PETER DEIXLER, ARLINGTON, MA (US); MUHAMMAD MOHSIN SIRAJ, EINDHOVEN (NL)

(21) Appl. No.: 19/145,061

(22) PCT Filed: Dec. 20, 2023
(86) PCT No.: PCT/EP2023/086866

§ 371 Date: Jul. 1, 2025

Related U.S. Application Data
(60) Provisional application No. 63/437,150, filed on Jan. 5, 2023.

(30) Foreign Application Priority Data
Feb. 2, 2023 (EP) 23154604.5

(51) Int. Cl. G08B 21/04; G08B 29/18

(52) U.S. Cl. CPC G08B 21/043; G08B 21/0453; G08B 29/186

(57) ABSTRACT

A method for determining a truthful label of a fall event is disclosed. The method comprises receiving signals from one or more sensors configured to measure from a distance signals indicative of characteristics of movement of a user, analyzing the received signals using a fall detection algorithm to determine a label indicative of a fall event by the user, initiating a first user interface interaction mode of a user interface, wherein in the first user interface interaction mode, the user interface is configured to receive a first input from the user indicative of a self-label of the fall event, receiving the first input and determining a level of mismatch between the self-label and the determined label. If the level of mismatch is above a threshold, the method further comprises switching the user interface to a second user interface interaction mode, wherein in the second user interface interaction mode, the user interface is configured to receive a second input from the user indicative of contextual information regarding the fall event, receiving the second input, and updating the self-label of the fall event based on the second input received.

### FIELD OF THE INVENTION

The invention relates to a method for determining a label of a fall event. The invention further relates to a controller for determining a label of a fall event. The invention further relates to a system determining a label of a fall event.

### BACKGROUND

Falling is a significant problem in elderly care that can lead to morbidity and mortality of the elderly. A fall may cause injuries to the elderly, but also, from a mental perspective, falls often cause a fear-of-falling, which in turn leads to social isolation and depression. With the ever-growing aging population, there is an urgent need for the development of fall detection and/or prevention systems. Thanks to the rapid development of sensor networks and advances in software technology (machine learning algorithms), fall detection systems can use a variety of sensors such as accelerometers, radar sensors, time of flight (ToF) sensors, Wi-Fi nodes, etc., to detect patterns in signals that are characteristic of a fall and thus determine whether a fall event has occurred or not.

However, although current fall detection systems work well under laboratory conditions, it is still problematic to produce reliable results when these systems are applied to real life conditions. Fall detection algorithms are typically pre-trained on training datasets containing mostly laboratory simulated fall data, using only a small number of available real-world fall data. To improve the accuracy of the fall detection system, the pre-trained fall detection algorithm needs to be refined (updated) to a specific elderly care facility and/or specific elderly behavior to better detect the corner cases of fall detection. A retrospective verification of fall times and types (retrospective labeling of fall events) is necessary to refine the fall detection algorithm to the specifics of the elderly/care facility and/or to the specifics of an elderly person's activities and motoric movements. Due to privacy regulations and further practical reasons, the labeling of fall events in real life conditions needs to be performed by either the elderly (self-labeling) or one or more care takers (or staff in a care facility).

### SUMMARY OF THE INVENTION

The inventors have realized that elderly people are often prone to under-reporting or deliberately lying about whether an incident constituted a fall. This can be either for fear of their independent living status being taken away, because the fall was caused due to their actions (e.g., actions such as getting up during the night to go to the toilet alone without calling the caretaker for help), due to memory loss, etc. Thus, the self-label provided by the elderly person to the fall detection system (e.g., via a user interface) may not be accurate or can even be deliberately faulty. A faulty (not accurate) label can severely compromise the accuracy of the fall detection system. Underreporting fall events, i.e., when the elderly person deliberately labels a fall event as no-fall, may lead to an increased number of false negatives in the fall detection system, comprising its ability to immediately report a fall. On the other hand, overreporting of fall events (i.e., elderly person self-labels a non-fall event as a fall) can lead to an increased number of false positives, leading to costly, unnecessary actions by the hospital and/or care facility and/or caretaker associated with an elderly person at home.

It is therefore an object to provide a method for determining a more accurate label of a fall event.

According to a first aspect, the object is achieved by a method for determining a label of a fall event. The method comprising the steps of: receiving signals from one or more sensors configured to measure signals indicative of characteristics of movement of a user: analyzing the received signals using a fall detection algorithm to determine a label indicative of a fall event, initiating a first user interface interaction mode of a user interface, wherein in the first user interface interaction mode, the user interface is configured to receive a first input from the user indicative of a self-label of the fall event, receiving the first input and determining a level of mismatch between the self-label and the determined label. If the level of mismatch is above a threshold, the method comprises switching the user interface to a second user interface interaction mode, wherein in the second user interface interaction mode, the user interface is configured to receive a second input from the user indicative of contextual information regarding the fall event, receiving the second input, and updating the self-label of the fall event based on the second input received.

Signals from one or more (remote) sensors such as radar sensors, time of flight (ToF) sensors, Wi-Fi Doppler sensors, microphone sensors, etc., may be used to determine characteristics (patterns) of movement and/or audio patterns of a user that are indicative of a fall. The patterns may include the fall event itself as well as the patterns preceding and following the fall. The fall detection and/or prevention algorithm analyzes the received sensor signals to determine a label indicative of a fall event associated with the received signals. The fall detection algorithm may have been trained to determine whether a fall has taken place or not based on received signals. For example, the determined label may indicate whether the received signals comprise a fall event or do not comprise a fall event, may indicate that the received signals comprise a type of a fall event, e.g., a fall with an injury, a fall without an injury, soft fall, brain stroke fall, near-fall (elderly person being out of balance without a fall to the floor), etc. To improve the accuracy of the fall detection algorithm to recognize a fall event and/or classify the specific type of fall event, the user may be asked to self-label the fall event. The user feedback (self-label of the fall event) is especially necessary in the case of remote sensing modalities with limited accuracy for determining a fall event. In the first user interface interaction mode, the user provides a self-label of the fall event. The self-label may indicate whether a fall event occurred or did not occur, may indicate the type of a fall event, e.g., a fall with an injury, a fall without an injury, etc.

When the received signal data is labeled, it may be used for re-training (updating) the fall detection algorithm to better recognize patterns of movement and/or audio characteristic of fall (or fall types) in the future. However, the self-label of the fall event provided by the user may be deliberately faulty and/or inaccurate, for example, for the reasons mentioned above. The method comprises determining a level of mismatch between the self-label provided by the user and the label of the fall event determined by the fall detection algorithm. If the level of mismatch is above a threshold, the method comprises switching the user interface interaction mode to a second mode, wherein the user interface is configured to receive a second input indicative of contextual information regarding (associated with) the fall event. That is, contextual data associated with the circumstances of the fall event to contextualize (provide a broader understanding to) the fall event as well being able to judge the truthfulness of the self-declaration about the fall event provided by the user. For example, the contextual data regarding the fall event may include the actions of the user preceding an event labeled as a fall. In another example, the user may be triggered/challenged to revisit his/her self-label of the event. In a further example, the contextual data may include information by the user supporting his/her self-label. The user may have initially provided a faulty and/or inaccurate self-label of the fall event. By explicitly being asked to provide further (contextual) information regarding the event, the user is triggered (challenged) to revisit, reconsider his/her initial self-labeling and provide an accurate (trustful) label of the event. This results in improved labeling and thereby can result in a more efficient update (re-training) of the fall detection algorithm.

The second input may comprise verbal and/or non-verbal cues. The method may further comprise analyzing the verbal and/or non-verbal cues in the second input to determine a user intent score, said user intent score being indicative of the user's intent to deceive the fall detection system (about the self-label), and updating the self-label of the fall event based on the user intent score. For example, the user intent score may be a probability (likelihood) that the user has provided a faulty self-label. Various Machine-Learning (ML) models and techniques may be used to determine a user's intent to deceive or not based on the verbal and non-verbal cues present in the user's answers as evidence for deception. For example, speech parameters including non-verbal parameters (cues), e.g., pitch, duration pattern, energy, and verbal parameters, e.g., filled pauses such as ‘um's’ or ‘ah's’, of the plurality of audible answers may be used as input to a speech ML model to determine a user's intent to deceive or not deceive when producing the audible answers. Natural Language Processing (NLP) models, such as stylometry models, may be used to determine (classify) whether (part of) text in the text answers of a user is deceptive or not based on the verbal (inconsistency of answers in the second user input) and non-verbal (linguistics) cues in the text answers. In another example, visual features in the video answers provided by the user in the second input may be used as input to a ML model, such as Support Vector Machine and Logistic Regression models, to determine a user's intent to deceive or not deceive when producing the video answers. For example, by analyzing micro-expressions and eye movements indicative of deception behavior. By associating a user intent score to the self-label provided by the user, the self-label may be accordingly updated. For example, if the user intent score is indicative that the user's intent is not to deceive, the self-label is updated according to the first user input. Alternatively, if the user intent score is indicative the user's intent is to deceive, the self-label is updated according to the contextual information. This further improves labeling and thereby can result in a more efficient update (re-training) of the fall detection algorithm. The method may further comprise storing the user intent score along with the updated self-label in a training set and updating the fall detection algorithm based on the training set. Updating the fall detection algorithm taking into consideration uncertainty associated with the user self-label can increase the accuracy and robustness of the fall detection algorithm, especially for fine tuning the fall detection/fall prevention system to the unique quirky behaviors of the elderly person and the elderly's specific room setup.

The method may further comprise receiving a further input indicative of physiological parameters of the user during the time period that the user provides the second input and analyzing the further input to determine the user intent score based on the physiological parameters of the user. When people lie, their physiological responses during an answer may be indicative of a stress-response which can be from lying. For example, a person that is lying may be more agitated showing increased heart rate and breathing rate or may sweat more (which causes changes in skin conductivity). By analyzing the physiological responses (parameters) of the user during the period that the user provides the second input, a better estimation of the user's intent to deceive may be achieved.

The method may further comprise obtaining historical (past) user intent scores of the user and determining the (current) user intent score depending on the historical user intent scores. A person that is found to intentionally deceive about the self-label of previous fall events may be more prone to provide a current inaccurate label of the fall event. Thus, by taking historic user intent scores into consideration, the current user intent score can be more accurately determined.

The step of receiving the second input indicative of contextual information regarding the fall event comprises receiving information regarding at least one of: actions of the user preceding the fall event, supporting evidence by the user regarding the fall event, location data of the fall event, time data of the fall event, presence of a further person (e.g., nurse) during the fall event, light setting (intensity and light spectrum) during and before the fall event. For example, although people may fall under different conditions for different reasons, there is a higher probability of falling when people are walking or going up/down the stairs. A large percentage of falls are caused by inappropriate sit-to-stand transfers. Similarly, elderly people are more likely to fall when they just get out of bed after a sleep due to the temporary muscle weakness and balance disorders. Thus, actions of the user preceding a fall event may be a good indicator of a fall event. Time and location of the fall comprise important information to give context to the fall event. For example, a large proportion of elderly falls occur during night visits to the toilet. Presence of another person during the fall may indicate that the elderly likely did not attempt to walk alone to the toilet, hence making a trip and fall event unlikely. The lighting (brightness levels) in the location of the fall may also contribute to a fall event. Similarly, the lighting (light intensity and spectrum) the elderly was exposed to in the day/hours before the fall may also contribute to a fall event. Research suggests that users exposed to circadian lighting (lighting setting designed to promote circadian health) have a 40% reduction in fall rates. Challenging the user to provide supporting evidence regarding the fall may trigger the user to re-consider the provided self-label or expose inconsistent answers indicative of a non-truthful self-declaration by the user. Hence, receiving contextual information (data) associated with the fall event enables a broader understanding of the fall event and triggers the elderly person to confirm/disconfirm his/her initial self-label of the fall event. In addition, the contextual information (data) enables to expose inconsistent answers with respect to sensing data from the fall.

In the second user interface interaction mode, the user interface may be configured to select a question setting from a group of default question settings and output the selected question setting to the user. For example, a group of default question settings may include questions like “What did you do before the fall event?”, “What is the location of the fall event?”, “Are you injured?”, etc. Outputting the selected question setting to the user may facilitate him/her in providing contextual information regarding the fall event.

Additionally, and/or alternatively, the user interface may be configured to determine a question setting based on a natural language processing (NLP) algorithm and output the determined question setting to the user. A powerful new class of large language models is making it possible for machines to generate text in natural human language. These large language models can generate a priori (not existing) follow up questions to the elderly in natural human language.

The user interface may be configured to determine a question setting based on the level of mismatch between the self-label and the determined label and output the determined question setting to the user. For example, the follow up questions (settings) may be customized based on the level of mismatch between the self-label and the determined label (by the fall detection algorithm). The level of mismatch between the self-label and the algorithm determined label may be indicative of the intention of the user to deceive or not.

Question style phrasing (e.g., friendly instead of confrontative) influences how people respond to a question. A strict confrontative question may lead to dissatisfaction of the user if the user's first input was truthful, however, if the user's first input was deceptive, such a question will prompt the user to provide an accurate self-label of the fall event. Thus, by optimizing the question style (selecting the question setting) based on the level of mismatch between the self-label and the determined label, a more accurate self-label may be determined.

The determining of the label indicative of the fall event may comprise determining a type of the fall event, and the first user interface interaction mode may be initiated when the determined fall event (the fall itself as well as the activities preceding and after the fall) is of a new type previously unseen. Labeling of fall events significantly improves the accuracy of fall detection. However, the elderly person may be annoyed if he/she is constantly being asked to provide a self-label of fall events. If a fall type is very common for that particular user (e.g., near fall with no injury), it may be unnecessary to probe the user to provide a self-label. However, if a previously unseen fall type is predicted by the fall detection algorithm, the fall detection algorithm may have low confidence in such prediction. Therefore, it is beneficial to initiate the first user interface interaction mode only upon determination of a new (unseen for this elderly) type of fall. For fall prevention of future falls, it is also important to accurately understand the context leading to the fall event.

Alternatively, the second user interface interaction mode may be conditioned on whether the determined fall event is of a new type. If a previously unseen fall type is predicted by the fall detection algorithm, more contextual information may be necessary for correctly updating the label of the fall event. Therefore, it is beneficial to initiate the second user interface interaction mode only upon determination of a new (unseen for this elderly) type of fall.

The method may further comprise receiving an input indicative of one or more characteristics of the user and determining a user interface input and/or output modality based on the one or more characteristics of the user. For example, the one or more characteristics of the user may comprise a health status, and an audio output modality, through an audio assistant device, or virtual reality device may be used for a user with a vision impairment. In another example, the one or more characteristics of the user may comprise a living status. A voice input modality with speech recognition may be used for a user that lives alone, while a keyboard input modality may be used for a user that lives in a shared facility. Adjusting the user interface input and/or output modality based on user characteristics and preferences enables a better user engagement with the user interface.

The method may further comprise receiving an input indicative of one or more characteristics of the user, determining a period of time for switching the user interface to the second user interface interaction mode, the period of time based on the one or more characteristics of the user and/or the user intent score and switching the user interface to the second user interface interaction mode after the determined period of time. The one or more characteristics of the user may comprise a psychological or physiological condition of the user. For example, a user with dementia or memory loss problems may be more prone to forget details regarding a fall event after long period of time has elapsed after the fall event. Thus, for that user, it may be beneficial that the second user interface mode is initiated immediately after the method has determined that the level of mismatch is above a threshold. On the other hand, for some users, it may be beneficial to probe them to provide contextual information regarding fall events at a later point in time (for example, when they less stressed/worried about a possible fall event or may be less agitated by being inquired about a false positive fall). Thus, it is beneficial to adapt the period of time for switching the user interface to the second user interface interaction mode based on the characteristics of the user.

The method may further comprise obtaining data indicative of a psychological and/or physiological condition of the user and determining the level of mismatch depending on the psychological and/or physiological condition of the user. Certain illnesses (e.g., people with a history of stroke, Parkinson's disease) and injuries are shown to have strong associations with falls. Additionally, people suffering with dementia and/or memory loss problems are more prone to inadvertently label a fall event inaccurately. By obtaining data indicative of a psychological and/or physiological condition of the user, the level of mismatch can be more accurately determined.

The method may further comprise determining whether the fall detection algorithm has provided a false positive and/or a false negative indication if there is a difference between the determined label by the fall detection algorithm and the updated self-label, storing the received signals along with the false positive and/or negative indication in a training set, and updating the fall detection algorithm based on the training set. The updated self-label provides a more accurate indication of whether a fall has actually taken place and/or an updated more accurate labeling of the type of fall. Thus, the fall detection algorithm can be updated to reduce the incidence of false positives and false negatives. This enables the fall detection algorithm to be adapted to a particular user's fall or activity characteristics, thereby improving the overall accuracy of the fall detection algorithm. The retraining may be done for a specific elderly and or a specific room layout. The retraining may utilize single-shot or few-shot learning.

According to a second aspect, the object is achieved by a controller for determining a label of a fall event, the controller configured to:
receive signals from one or more sensors configured to measure signals indicative of characteristics of movement of a user:
analyze the received signals using a fall detection algorithm to determine a label indicative of a fall event by the user:
initiate a first user interface interaction mode of a user interface, wherein in the first user interface interaction mode, the user interface is configured to receive a first input from the user indicative of a self-label of the fall event:
receive the first input:
determine a level of mismatch between the self-label and the determined label:
if the level of mismatch is above a threshold, switch the user interface to a second user interface interaction mode, wherein in the second user interface interaction mode, the user interface is configured to receive a second input from the user indicative of contextual information regarding the fall event,
receive the second input, and
update the self-label of the fall event based on the second input received.

According to a third aspect, the object is achieved by a system for determining a label of a fall event, the system comprising:
one or more sensors configured to measure signals indicative of characteristics of movement of a user:
a controller as described above.

According to a fourth aspect, the object is achieved by a computer program product for a computing device, the computer program product comprising computer program code to perform the method for determining a label of a fall event when the computer program product is run on a processing unit of the computing device.

It should be understood that the controller, system and computer program product may have similar and/or identical embodiments and advantages as the above-mentioned lighting devices.

### BRIEF DESCRIPTION OF THE DRAWINGS

The above, as well as additional objects, features and advantages of the disclosed systems, devices and methods will be better understood through the following illustrative and non-limiting detailed description of embodiments of devices and methods, with reference to the appended drawings, in which:

FIG. 1 shows schematically an example of system for determining a label of a fall event:

FIG. 2 shows schematically an example of a user interface in a personal device:

FIG. 3 shows schematically a method for determining a label of a fall event.

All the figures are schematic, not necessarily to scale, and generally only show parts which are necessary in order to elucidate the invention, wherein other parts may be omitted or merely suggested.

### DETAILED DESCRIPTION

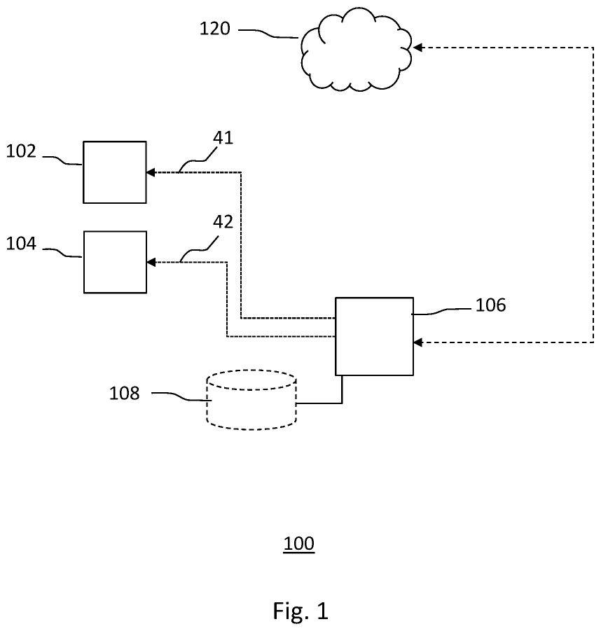

FIG. 1 shows an example of a system 100 for determining a label of a fall event. The system 100 comprises one or more sensors 102, 104 configured to measure signals 41, 42 indicative of characteristics of movement of a user. The one or more sensors 102, 104 may for example be radar sensors, Wi-Fi nodes, infrared (IR) sensors, acoustic sensors and/or other sensors. In an example, the one or more sensors 102, 104 may be co-located with a lighting device (not depicted). The signals 41, 42 from the one or more sensor(s) 102, 104 form a feature set, possibly after some processing. Exemplary features may include magnitude, spectral content, directional distribution, mean, variance, etc., but alternatively the signals themselves, i.e. the time series of sample values, e.g., time-series values of channel state information (CSI) in Wi-Fi signals, can serve as feature set. For example, different motions and positions introduce different multipath distortions in WiFi signals and generate different patterns in the time-series values of channel state information (CSI). Thus, time-series values (signals 41, 42) of channel state information (CSI) from Wi-Fi nodes may be used to determine patterns characteristic of the movement of the user during a fall.

The system 100 further comprises at least one data processor or controller 106. The controller 106 may be configured to receive the signals 41, 42 from the one or more sensors 102, 104. The controller 106 may be in connection and communication with each sensor 102, 104 via a wireless connection, via e.g., a radiofrequency or an optical communication link. For example, Wi-Fi, ZigBee, BLE, Lo-Ra, UWB, VLC, IR, Li-Fi, etc., connection. Said connection may alternatively be wired. Each sensor 102, 104 may comprise a transmitter (not depicted) for transmitting at least a subset of the respective signals 41, 42, or the extracted features to the controller 106 via the wired or wireless connection. The controller 106 may comprise a receiver (not depicted) for receiving each respective signals 41, 42, or the extracted features from the respective sensor 102, 104. The system 100 may further comprise at least one data repository or storage or memory 108 for storing computer program code instructions. The controller 106 may be communicatively coupled to the cloud 120. Yet alternatively, the system 100 may comprise a server. Each sensor 102, 104 may convey their respective signal 41, 42, or the extracted features to the server (or cloud), such that the server may obtain each respective signal 41, 42, or the extracted features. The controller 106 may then be configured to retrieve (receive) each respective signal 41, 42, or the extracted features from the server.

The controller 106 may be configured to analyze the received signals 41, 42, or the extracted features using a fall detection and/or prevention algorithm to determine a label indicative of a fall event. For example, the determined label may indicate whether the received signals 41, 42, or extracted features comprise a fall event or do not comprise a fall event, may indicate that the received signals 41, 42 comprise a type of a fall event, e.g., a “fall with an injury”, “a fall without an injury”, etc. Further fall event types may include a “trip and fall” event (i.e., a fast fall from the walking position to the ground), a “fall entering a chair” event, a “soft fall” event (i.e., user grabs a furniture to slow the fall to the ground), a “brain stroke fall” event (i.e., a fall from standing position first to one knee and subsequently down to the ground), a “pick-from-ground fall” event (i.e., prolonged fall occurring when user tries to pick up something from the ground). The trained fall detection and/or prevention algorithm may make such a determination because the algorithm may have already been trained with inputs that may include instances or segments (time series data) of signals 41, 42 received from sensors 102, 104 (or extracted features) and output corresponding labeled instances of fall and/or non-fall incidents (events) and/or types of incidents (fall events). In particular, the fall detection algorithm may determine whether a fall event or a type of fall event has taken place by comparing the signals 41, 42, or the extracted feature set, to a set of parameters that are used to classify whether a fall (or a type of fall) has taken place or not. These parameters can include, or be based on, feature sets from known (types of) falls, for example, from a training set.

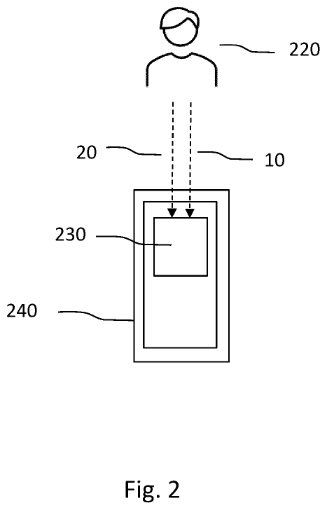

FIG. 2 shows an example of a user interface 230 in a personal device 240. The controller 106 may be further configured to initiate a first user interface interaction mode of the user interface 230, wherein in the first user interface interaction mode, the user interface 230 is configured to receive a first input 10 from the user 220 indicative of a self-label of the fall event. The self-label may indicate whether a fall event occurred or did not occur, may indicate the type of a fall event, e.g., a fall with an injury, a fall without an injury, etc. The user 220 may be asked, via the user interface 230 in the personal device 240, to provide a textual and/or voice self-label of the fall event and/or activity preceding the fall event. In an example, the personal device 240) may comprise a voice assistant device and the user 220 may be asked by the user interface 230 in the personal voice assistant device 240 to provide a textual and/or voice self-label of the fall event. In yet another example, the personal device 240 may comprise a virtual or augmented reality device, e.g., virtual reality headset, and the user 220 may be presented via the virtual or augmented reality device 240 a fall event and asked to provide a textual and/or voice self-label of the fall event. In a further example, the user 220 may press a button, for example in a wearable device, to confirm/deny a label of a fall event. Said button may be an alarm reset button connected to an alarm signal generated if the fall detection algorithm determines a fall. If the user presses the alarm reset button within a within a predetermined time-out period (which may be zero), the label of the event is a non-fall. Otherwise, if no alarm reset signal is received within the time-out period, the label is a fall.

The controller 106 may be further configured to receive the first input 10. For example, the controller 106 may be in connection and communication with the user interface 230 via a wireless connection, via e.g., a radiofrequency or an optical communication link. Said connection may alternatively be wired. The controller 106 may be comprised in the same device 240) as the user interface 230. The device 240 may comprise a transmitter (not depicted) for transmitting the first user input 10 to the controller 106 via the wired or wireless connection. The controller 106 may comprise a receiver (not depicted) for receiving the first user input 10. Alternatively, the device 240 may convey the first user input 10 to a server (or cloud 120), and the controller 106 may then be configured to retrieve (receive) the first user input 10 from the server.

The controller 106 may be further configured to determine a level of mismatch between the self-label by the user 220 and the determined label by the fall detection and/or prevention algorithm. For example, the controller 106 may apply a weighted average algorithm on the labels (by the user and by the fall detection algorithm) to determine said level of mismatch. For example, if the fall detection algorithm predicted a 60% probability of fall and user self-label indicated a non-fall (0% probability of fall), the level of mismatch is determined (by the controller 106) as 30% assuming equal weights for the fall detection algorithm and the self-label by the user. In another example, the determined level of mismatch may be determined as 50% assuming a higher weight for the label predicted by the fall detection algorithm. In a further example, the controller 106 may determine said level of mismatch by applying a confidence learning machine-leaning algorithm on the labels. Such confidence-based models for characterizing noisy labels and identifying mismatches between labels associated with the same event are known in the field of supervised learning and will not be further discussed in the context of this application.

If the level of mismatch is above a threshold, the controller 106 may be configured to switch the user interface 230 to a second user interface interaction mode, wherein in the second user interface interaction mode, the user interface 230 is configured to receive a second input 20 from the user 220 indicative of contextual information regarding the fall event. The contextual data provided as the second input 20 regarding the fall event may include the actions of the user preceding an event labeled as a fall. In another example, the user may be triggered/challenged to revisit his/her self-label of the event. This may be done for instance by saying to the user that “75% of the user's asked to clarify a trip and fall self-declaration refined their answer after receiving additional information”. In a further example, the contextual data may include information by the user supporting his/her self-label. In another example, the contextual data may include location data of the fall event, for example GPS location data from a sensor device attached to the user 220, context location data from the user 230, e.g., location of the fall event is kitchen, bathroom, living room, etc. In yet another example, the contextual data may include time data, for example, time of the day data received by a sensor attached to the user 230, and/or time data received from the user 230. The contextual data my further include the lighting setting (spectrum and/or intensity) during or before the fall. For example, the user may provide information on whether(s) he had turned on (off) the lights before the fall event.

In the second user interface interaction mode, the controller 106 may be configured to select at least one question setting from a group of default question settings and output one or more of the selected question settings to the user 220, for example via the user interface 230 in the personal device 240. For example, a group of default question settings may include questions like “What did you do before the fall event?”, “What is the location of the fall event?”, “Are you injured?”, “What is the date”, “Are you sure that this is the correct label?”, “What problems are there with your initial answer?”, etc. The controller 106 may be configured to select one or more (or all) of the default (predetermined) question settings and output the selected question settings to the user 220. The default question settings may be stored in a memory 108 or cloud 120.

Additionally, and/or alternatively, the controller 106 may be configured to determine a-customized to the specific user-question setting in natural human language, for example by using a Natural Language Processing algorithm. For example, the question setting, e.g., a follow up question, may be customized based on the second user input (e.g., contextual information regarding the fall), historic data about earlier fall events of the user, specifics of the user, etc. For example, it may be known (e.g., from a caretaker or from camera images) that a first dementia patient likes to play with extension cords on the floor and when bending forward for longer time to reach the cables(s) he may get dizzy. The elderly person however already knows that(s) he is not supposed to self-lower themselves to the floor and hence if caught often initially or even vehemently deny that(s) he has (again) self-lowered to the floor. The question setting may be customized to that case of purposely self-lowering to the floor. Methods and techniques for producing text in natural human language are known in the field and will not be discussed in detail in the context of this application.

The controller 106 may be further configured to determine a question setting based on the level of mismatch between the self-label and the determined label and output the determined question setting to the user. The controller 106 may for example be configured to select a more aggressive style question setting, e.g., “What problems are there with your initial answer?” when the level of mismatch between the self-label and the determined label is high (above a threshold) and a more friendly style question setting, e.g., “Are you sure that this is the correct label?” when the level of mismatch between the self-label and the determined label is moderate (below a threshold). The question settings may be selected from a group of default question settings classified according to the level of mismatch and/or based on a conditional natural language processing algorithm conditioned on the style of question based on the level of mismatch.

The controller 106 may be configured to update the self-label of the fall event based on the second input 20 received via the user interface 230. For example, the controller 106, may be configured to analyze the received contextual data, for example using a natural language processing algorithm (NLP), to determine the updated (more accurate) self-label.

The second input may comprise verbal and/or non-verbal cues. The controller 106 may be further configured to analyze the verbal and/or non-verbal cues in the second input to determine a user intent score and update the self-label of the fall event based on the user intent score. Various Machine-Learning models (ML) and techniques may be used to determine a user's intent to deceive or not based on the verbal and non-verbal cues present in the user's answers as evidence for deception. For example, speech parameters including non-verbal parameters, e.g., pitch, duration pattern, energy, and verbal parameters, e.g., filled pauses such as ‘um's’ or ‘ah's’, of the plurality of audible answers may be used as input to a speech ML model to determine a user's intent to deceive or not deceive when producing the audible answers. Natural Language Processing (NLP) models, for example stylometry models, may be used to determine (classify) whether (part of) text in the text answers of a user is deceptive or not deceptive based on the verbal cues (inconsistencies in answers provided as second input) and non-verbal features such as word count, count of words larger than 6 letters, etc., (a liar may use more simplified form of language) in the text answers. For example, it is known that deceptive linguistic style includes fewer first-person singular pronouns, fewer third-person pronouns, fewer exclusive words, more negative emotion words and more motion verbs. In another example, visual features in the video answers by the user may be used as input to a ML model, such Support Vector Machine and Logistic Regression models, to determine a user's intent to deceive or not deceive when producing the video answers. For example, by analyzing micro-expressions and eye movements indicative of deception behavior. Such ML models and techniques for analyzing textual, voice or video content to detect deception are known in the field and will not be discussed in detail in the context of the present application. The controller 106 may be configured to update the self-label of the fall event based on the user intent score. For example, if the user intent score is indicative that the user's intent is not to deceive, e.g., user intent score to deceive is below a threshold, say 50%, the self-label is updated according to the first user input. The controller 106 may be further configured to store the user intent score along with the updated self-label in a training set and update the fall detection algorithm based on the training set. The training set may be stored in a memory 108 and/or the cloud 120. The stored information may be for example used to adapt or re-train the algorithm, e.g., adjust a loss function of the algorithm to reflect the user intent scores in the updated training dataset.

The controller 106 may be further configured to obtain historical (past) user intent scores of the user (e.g., a user may have provided answers in the past which have questionable truthfulness) and determine the current user intent scores based on the historical (past) scores of the user. For example, the controller 106 may determine the current user intent scores as a weighted average of past (historical) and the current user intent scores of the user. In an example, said weights may be equal. Alternatively, the controller 106 may determine the current user intent scores by assigning a higher weight on the past user intent scores.

The controller 106 may be further configured to obtain data indicative of physiological parameters of the user of the user and determine the user intent score further based on the physiological parameters of the user. For example, the controller 106 may be configured to receive input from one or more sensors monitoring physiological parameters of the user during the period that the user provides the second input 20, e.g., input from ECG (Electrocardiogramhy) sensors, PPG (Photoplethysmography) sensors monitoring heart-rate of the user, radar sensors monitoring heart-rate and/or breathing rate of the user, etc. This input may be used as input to a ML model to determine the user's intent to deceive or not. The ML model may make such a determination as it may have been trained to detect deception using known instances of sensor signals associated with deception in a training set.

The controller 106 may be configured to determine a type of fall event, e.g., “fall with injury”, “fall entering a chair”, “soft fall”, etc., by analyzing the received signals 41, 42 or features extracted from the received signals. The controller 106 may be configured to initiate the user interface 230 according to the first user interface interaction mode upon the determination that a fall event is of a new type. That is, the controller 106 may initiate the first user interaction mode in the condition that a previously unseen type of fall for this user is determined by the fall detection algorithm. In another example, the controller 106 may be configured to switch the user interface 230 to the second user interface interaction mode only when a fall event of a new type is determined by the fall detection algorithm.

The controller 106 may be further configured to receive an input indicative of one or more characteristics of the user and determine a user interface input and/or output modality (unimodal or multimodal) based on the one or more characteristics of the user. The input may comprise medical health records of the user indicative of a physiological and/psychological condition of the user, a living status of the user, signals from one or more sensors monitoring the user, etc. The one or more user interface output modalities may comprise vision (computer graphics through a screen), audio, vibration, etc. For example, the one or more characteristics of the user may comprise a physiological and/psychological condition of the user. An audio output modality, through an audio assistant device, or virtual reality device may be used for a user with a vision impairment. In another example, a vision output modality, through a screen in a personal device, may be used for a user with an audio impairment, etc. In another example, the one or more characteristics of the user may comprise a stress status of the user (e.g., based on heart-rate monitoring). A vision output modality, through a screen in a personal device, may be used for a user under stress compared to an audio assistant device (which may contribute to increasing the stress levels of the user). The one or more user interface input modalities may comprise a keyboard input, a pointing device, a touchscreen, and/or more complex modalities such as computer vision, speech recognition, motion, orientation, etc. For example, the one or more characteristics of the user may comprise a living status. A voice input modality with speech recognition may be used for a user that lives alone, while a keyboard input modality may be used for a user that lives in a shared facility.

The controller 106 may be further configured to determine a period of time for switching the user interface 230 to the second user interface interaction mode and switching the user interface 230 to the second user interface interaction mode after said period of time. The period of time may be based on the one or more characteristics of the user. For example, for controller 106 may determine a short(er) period of time for a user that has a medical condition associated with memory loss. In a further example, the controller 106 may determine a late(r), longer period of time for a user that is currently experiencing a psychological and/or physiological condition associated with stress.

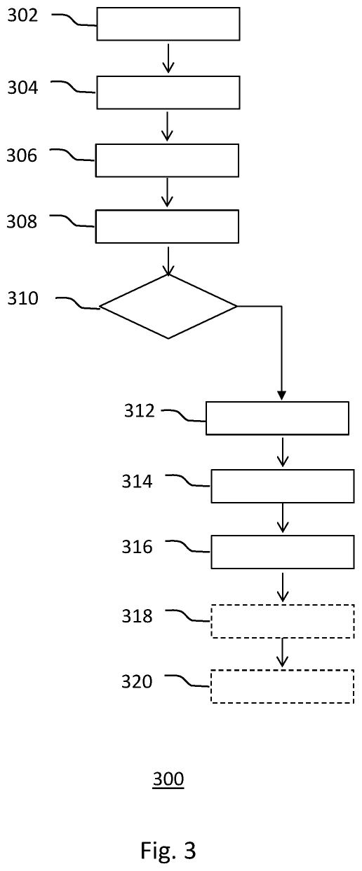

FIG. 3 shows an example of a method 300 for determining a label of a fall event, the method comprising the steps of:
receiving (302) signals from one or more sensors 102, 104 configured to measure signals 41, 42 indicative of characteristics of movement of a user 220;
analyzing (304) the received signals using a fall detection algorithm to determine a label indicative of a fall event by the user:
initiating (306) a first user interface interaction mode of a user interface, wherein in the first user interface interaction mode, the user interface is configured to receive a first input from the user indicative of a self-label of the fall event:
receiving (308) the first input:
determining (310) a level of mismatch between the self-label and the determined label:
if the level of mismatch is above a threshold, switching (312) the user interface to a second user interface interaction mode, wherein in the second user interface interaction mode, the user interface is configured to receive a second input from the user indicative of contextual information regarding the fall event,
receiving (314) the second input, and
updating (316) the self-label of the fall event based on the second input received.

The method 300 may be executed by computer program code of a computer program product when the computer program product is run on a processing unit of a computing device, such as the controller 106.

In an example, the method 300 may further comprise the optional steps of determining 318 whether the fall detection algorithm has provided a false positive and/or a false negative indication if there is a difference between the determined label by the fall detection algorithm and the updated self-label, storing 320 the received signals 41, 42 along with the false positive and/or negative indication in a training set, and updating 322 the fall detection algorithm based on the training set. During operation of the fall detection and/or prevention algorithm, instances of received signals 41,42, or extracted features from the received signals 41, 42 may be stored in a training set in the memory 108 and/or cloud 120 to update the algorithm. The algorithm may use the (updated) training set to compare current signals/features with those in the (updated) training set to determine a current label of the event. To improve the training of the algorithm, the instances of signals/features may be stored together with a value indication of the performance of the algorithm. For example, in the case that label determined by the fall detection algorithm indicates a fall, but the updated self-label indicates a non-fall, the received signals 41, 42 or extracted features may be labeled to represent a false positive (FP) and stored with a FP indication in the training set. In the case that label determined by the fall detection algorithm does not indicate a fall, but the updated self-label indicates a fall, the received signals 41, 42 or extracted features may be labeled to represent a false negative (FN) and stored with a FN indication in the training set. Signals 41, 42 and feature sets for which the updated self-label is the same as the label determined by the algorithm may be stored either as a TP (true positive) or TN (true negative), respectively. The stored information may be for example used to adapt or train the algorithm to reduce the rates of false positives and false negatives.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors or even the ‘cloud’.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A method for determining a label of a fall event, the method comprising the steps of:
receiving signals from one or more sensors configured to measure signals indicative of characteristics of movement of a user;
analyzing the received signals using a fall detection algorithm to determine a label indicative of a fall event by the user;
initiating a first user interface interaction mode of a user interface, wherein in the first user interface interaction mode, the user interface is configured to receive a first input from the user indicative of a self-label of the fall event;
receiving the first input;
determining a level of mismatch between the self-label and the determined label;
if the level of mismatch is above a threshold, switching the user interface to a second user interface interaction mode, wherein in the second user interface interaction mode, the user interface is configured to receive a second input from the user indicative of contextual information regarding the fall event,
receiving the second input, and
updating the self-label of the fall event based on the second input received.

2. The method according to claim 1, wherein the second input comprises verbal and/or non-verbal cues, and wherein the method further comprises:
analyzing the verbal and/or non-verbal cues to determine a user intent score, said user intent score being indicative of the user's intent to deceive, and
updating the self-label of the fall event based on the user intent score.

3. The method according to claim 2, wherein the method further comprises:
receiving a further input indicative of physiological parameters of the user;
analyzing the further input to determine the user intent score based on the physiological parameters of the user.

4. The method according to claim 2, wherein the method comprises:
obtaining historical user intent scores of the user, and
determining the user intent score based on the historical user intent scores of the user.

5. The method according to claim 1, wherein the step of receiving the second input indicative of contextual information regarding the fall event comprises receiving information regarding one of: actions of the user preceding the fall event, supporting evidence regarding the fall event, time data, location data, presence of a further person during the fall event, a light setting during and before the fall event.

6. The method according to claim 1, wherein in the second user interface interaction mode, the user interface is configured to select a question setting from a group of default question settings and output the selected question setting to the user.

7. The method according to claim 1, wherein in the second user interface interaction mode, the user interface is configured to determine a question setting based on a natural language processing algorithm and output the determined question setting to the user.

8. The method according to claim 1, wherein in the second user interface interaction mode, the user interface is configured to determine a question setting based on the level of mismatch between the self-label and the determined label and output the determined question setting to the user.

9. The method according to claim 1, wherein the determining of the label indicative of the fall event comprises determining a type of the fall event, and wherein the first user interface interaction mode is initiated when the determined fall event is of a new type.

10. The method according to claim 1, wherein the determining of the label indicative of the fall event comprises determining a type of the fall event, and wherein the second user interface interaction mode is conditioned on whether the determined fall event is of a new type.

11. The method according to claim 1, wherein the method further comprises receiving an input indicative of one or more characteristics of the user and determining a user interface input and/or output modality based on the one or more characteristics of the user.

12. The method according to claim 1, wherein the method comprises:
receiving an input indicative of one or more characteristics of the user;
determining a period of time for switching the user interface to the second user interface interaction mode, the period of time based on the one or more characteristics of the user and/or the user intent score of the self-label;
switching the user interface to the second user interface interaction mode after the determined period of time.

13. A controller for determining a label of a fall event, the controller configured to:
receive signals from one or more sensors configured to measure signals indicative of characteristics of movement of a user;
analyze the received signals using a fall detection algorithm to determine a label indicative of a fall event by the user;
initiate a first user interface interaction mode of a user interface, wherein in the first user interface interaction mode, the user interface is configured to receive a first input from the user indicative of a self-label of the fall event;
receive the first input;
determine a level of mismatch between the self-label and the determined label;
if the level of mismatch is above a threshold, switch the user interface to a second user interface interaction mode, wherein in the second user interface interaction mode, the user interface is configured to receive a second input from the user indicative of contextual information regarding the fall event,
receive the second input, and
update the self-label of the fall event based on the second input received.

14. A system for determining a label of a fall event, the system comprising:
one or more sensors configured to measure signals indicative of characteristics of movement of a user;
a controller according to claim 13.

15. A computer program product for a computing device, the computer program product comprising computer program code to perform the method of claim 1 when the computer program product is run on a processing unit of the computing device.
